(19) United States
(12) Patent Application Publication
(10) Pub. No.: US 2008/0030899 A1
(43) Pub. Date: Feb. 7, 2008

(54) Dual sided uni-directional media for bi-directional linear tape drives

(75) Inventor: David E. Norton, Boulder, CO (US)

Correspondence Address: MORRISON & FOERSTER LLP, 755 PAGE MILL RD, PALO ALTO, CA, 94304-1018, US

(73) Assignee: Quantum Corporation, San Jose, CA (US)

(21) Appl. No.: 11/500,765

(22) Filed: Aug. 7, 2006

(51) Int. Cl. G11B 5/78

(52) U.S. Cl. 360/134

(57) ABSTRACT

According to one aspect of the present invention a data storage tape is provided. In one example, the data storage tape comprises a substrate having a first recording layer and a second recording layer disposed on opposite sides of the substrate. Further, the first and second recording layers are uni-directional, and oriented in opposite directions on the first and second sides. In one example, the recording material includes an Advance Metal Evaporated (AME), and is generally suitable for vertical recording. Additionally, the tape may include various other layers and materials, for example, a coating on one or both major sides for reducing adhesion to the opposite major side (when wound on a cartridge or take-up reel, for example).

### BACKGROUND

1. Field

The present invention and its various aspects relate generally to magnetic storage media and magnetic storage drive systems, and in one example to a flexible magnetic storage tape comprising dual sided coatings of Advanced Metal Evaporated (AME) material for use in a bi-directional linear tape drive system.

2. Related Art

Increased data storage capacity and retrieval performance is desired of all commercially viable mass storage devices and media, including magnetic tape cartridges. For example, a popular trend is toward multi head, multi-channel fixed or servo (positioning) head structures with narrowed recording gaps and data track widths so that many linear data tracks may be achieved on a tape medium of a predetermined width, such as one-half inch width tape. To increase the storage density for a given cartridge size, the bits on the tape may be written to smaller areas and on a plurality of parallel longitudinal tracks. As more tracks are recorded on the tape, each track becomes increasingly narrow. As the tracks become more narrow, the tape becomes more susceptible to errors caused from the tape shifting up or down (often referred to as lateral tape motion or “LTM”) in a direction perpendicular to the tape travel path as the tape passes by the magnetic head. In order to maintain proper alignment of the head with the data tracks on the tape, the tape is generally mechanically constrained to minimize lateral tape motion and data retrieval errors.

Tape substrates are also being made thinner to increase data storage for a given cartridge size. Thinner tape allows more tape to be contained within the same size diameter reel cartridges, e.g., a standard DLT™ cartridge of about four inches square and one inch high for use with a five and one quarter inch tape drive. Increasing the tape within a given cartridge increases the data storage capacity of the cartridge. Thinner tapes, however, are generally less rigid making them more susceptible to lateral tape motion errors and damage or wear to the tape; in particular, damage to the tape edges. For example, guides and rollers that may be used, e.g., to define a tape path through a tape drive and reduce lateral tape motion, may cause damage to edge portions of the tape.

Additionally, dual sided magnetic tape has been proposed and used in the past in an attempt to increase storage capacity for a given sized cartridge. Dual sided magnetic tape, however, in practice has been found to have several drawbacks. For example, one drawback often associated with dual sided magnetic tape is print through, occurring generally when writing to the magnetic tape on one side and altering the magnetization (and thus data) located on the other side of the magnetic tape. Another drawback often associated with dual sided magnetic tape is contact recording, occurring when recording layers come in physical contact with each other. For example, when the tape is wound on a reel, and recording layers are in contact, magnetization of the recording material on adjacent layers may be altered. Both of these issues may reduce the performance of the media.

One solution for these drawbacks is proposed by U.S. Pat. No. 5,850,328, which provides a method and system wherein data is written on both sides of the magnetic recording tape in directions of magnetization that are of sufficient angular displacement relative to each other to reduce the effects of contact recording and magnetic print through. The magnetic recording materials on each side of the tape include substantially identical bulk magnetic properties (e.g., MP recording layers), where the magnetic particles of magnetic material on each side are aligned in different orientations, and generally disposed longitudinally (e.g., parallel to the tape surface or substrate).

There remains a desire to increase the storage capacity of magnetic recording materials, particularly, for use in a bi-directional linear tape drives.

### SUMMARY

According to one aspect of the present invention a dual sided data storage tape is provided. In one example, the data storage tape comprises a substrate having a first recording layer and a second recording layer disposed on opposite sides of the substrate. Further, the first and second recording layers are uni-directional (e.g., wherein writing data to the recording layer is more efficient or effective in one direction than others due to characteristics of the material or structure of the recording layer), and the first and second recording layers are oriented in different (e.g., opposite) directions on the first and second sides.

In one example, the recording layers include an Advanced Metal Evaporated (AME) coating or other uni-directional recording layer. Further, the recording layer (including, e.g., an AME coating) may be suitable for vertical recording. The tape may include various other layers and materials, for example, a protective or lubricant coating on one or both major sides for reducing adhesion to the opposite major side (when wound on a cartridge or take-up reel, for example) and providing desired wear characteristics.

In another example, a dual-sided data storage tape includes a flexible substrate having first and second major surfaces, a first advanced metal evaporated coating disposed on the first major surface, the first metal evaporated coating oriented in a first direction, and a second advanced metal evaporated coating disposed on the second major surface, the second metal evaporated coating oriented in a second direction, the second direction different that the first direction.

According to another aspect of the invention, a media drive for use with dual sided tape media is provided. In one example, the drive includes a first head disposed on a first side of a tape path, the first head for data transfer operations associated with a first uni-directional recording layer oriented in a first direction, and a second head disposed on a second side of the tape path, the second head for data transfer operations associated with a second uni-directional recording layer oriented in a second direction, wherein the first direction and second direction are oriented in non-identical directions.

In one example, the drive may operate in a bi-directional manner, wherein the first head is operable for data transfer operations in a first direction of tape transport (e.g., forward direction), and the second head is operable for data transfer operations in a second direction of tape transport (e.g., backward/reverse direction). Further, the uni-directional recording layers may include AME coatings or the like.

According to another aspect of the invention, a method for manufacturing a dual sided tape media is provided. In one example, the method includes disposing a first recording layer on a first side of a substrate, the first recording layer comprising a uni-directional recording layer, and disposing a second recording layer on a second side of a substrate, the second recording layer comprising a second uni-direction recording layer, the orientation of the second recording layer different than that of the first recording layer.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

For a fuller understanding of aspects and examples disclosed herein, reference is made to the accompanying drawings in the following description.

FIG. 1 illustrates a conventional process for coating a substrate or base layer with an advanced metal evaporated (AME) recording material;

FIG. 2 illustrates a schematic cross-sectional view of an exemplary uni-directional recording material adjacent a write element during a writing process;

FIG. 3 illustrates (not shown to scale) an exemplary storage media having first and second AME coatings disposed on opposite major sides of a substrate, the AME coatings oriented in opposite directions;

FIG. 4 illustrates (not shown to scale) an exemplary storage media having dual sided uni-directional recording layers disposed on opposite major sides of a substrate, the uni-directional recording layers oriented in opposite directions; and

FIG. 5 illustrates an exemplary tape drive for using an exemplary storage tape according to presently presented aspects.

### DETAILED DESCRIPTION

The following description is presented to enable a person of ordinary skill in the art to make and use various aspects of the inventions. Descriptions of specific materials, techniques, and applications are provided only as examples. Various modifications to the examples described herein will be readily apparent to those skilled in the art, and the general principles defined herein may be applied to other examples and applications without departing from the spirit and scope of the inventions. For example, a variety of recording materials, layers, and configuration may be used according to the described examples; a variety of tape drive designs may operate according to the described examples; and a variety of methods may be used for creating a storage tape according to the described examples.

Magnetic tape drives generally operate by streaming storage tape from a cartridge reel and spooling the storage tape on a drive take-up reel, which may be described as operating in a forward direction; additionally, a magnetic tape drive may operate by pulling tape from the take-up reel and spooling back onto a cartridge reel, which may be designated as operating in a reverse direction. The tape path includes a data transducer head that has read and write head portions. During forward operation, the head is used to conduct read and/or write operations on a portion of the longitudinal tracks. After the storage tape has been pulled an amount (e.g., the tape has been entirely pulled from the cartridge reel and spooled on the take-up reel), the drive may operate in the reverse direction, whereby other of the longitudinal tracks not used during the forward operation may be read from and/or written to. By operating the drive in both forward and reverse directions, throughput of the drive may be increased as rewind operations are not required before further read/write operations may begin.

The ability to operate a linear tape drive in both forward and reverse operations is enabled, in part, by characteristics of conventional MP tape media. For example, generally, a Magnetic Particle (MP) coating applied to tape can be read and written in either the forward or reverse direction without negatively impacting the recording capacity.

In one example provided herein, a data storage tape includes a substrate having a recording layer disposed on opposite major sides thereof (or at least adjacent thereto, i.e., an additional layer of material may be disposed between one or both of the recording materials and the substrate). The recording layer comprises a uni-directional recording material (e.g., writing data to the material is more efficient or effective in one direction due to characteristics of the material or structure of the recording layer). One exemplary uni-directional recording material includes an Advanced Metal Evaporated (AME) coating. The recording layers are oriented in opposite directions with the substrate, e.g., a first direction on the first side of the substrate and in an opposite, second direction on the opposing second side of the substrate.

A data storage tape having dual sided, uni-directional recording layers may be used within a magnetic storage drive having heads positioned for data transfer functions on both major sides of the data storage tape. In one example, each head operates in a unidirectional fashion similar to conventional linear tape drives, and together may operate similar to conventional bi-directional magnetic storage tape described above. Certain uni-directional recording material, such as AME, may allow for increased storage capacity relative to conventional recording materials such as MP recording materials, thereby increasing the storage capacity for a given length of magnetic storage tape or cartridge size, and allowing for conventional bi-directional operation with a linear tape drive.

Certain features of the examples described herein may be aided by a brief description of general characteristics and manufacturing process of AME media (which is typically uni-directional). In contrast to storage tape including an MP recording layer, AME media is generally made by evaporating cobalt using, e.g., an electron beam, and providing a small amount of oxygen to create an oxide of the cobalt. The cobalt oxide forms a passive layer, isolating magnetic domains from each other, and passivating the tape substrate. Typically, AME designs are absent a binder material, which consumes volume of the recording layer, thereby reducing the volume available to active recording material and reducing the storage capacity of the media.

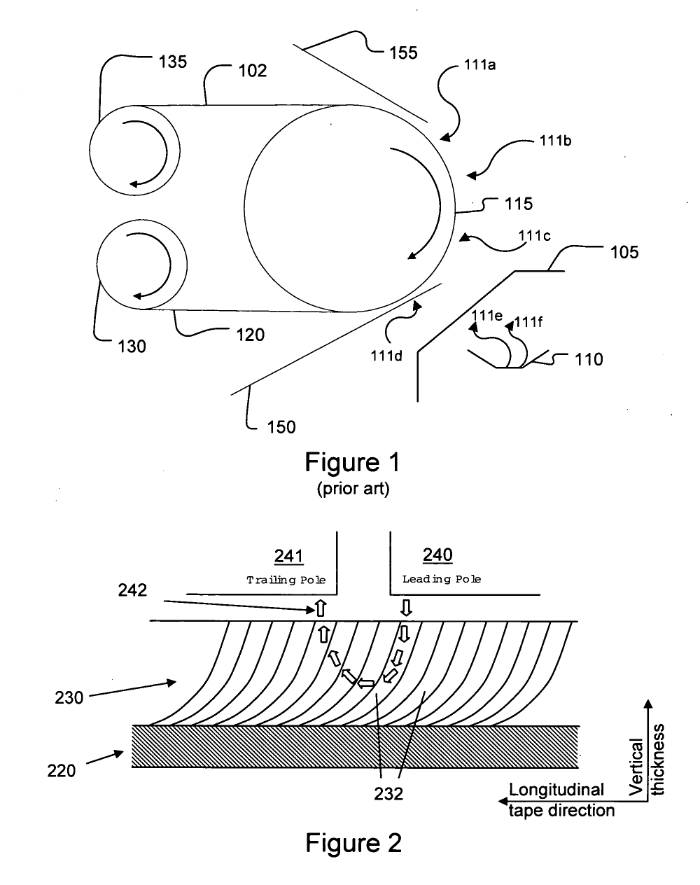

Further, AME media is generally uni-directional; for example, a write head may record more efficiently and/or at a greater density in one direction versus an opposite direction. The uni-directional nature of AME media is largely due to how AME media is typically manufactured as illustrated, for example, in FIG. 1. In particular, FIG. 1 schematically illustrates a conventional system for manufacturing AME media. A first spool 135 of tape substrate 102 is provided. The tape substrate 102 from the first spool 135 is threaded around a cooling drum 115. The tape substrate 102 is rolled over an outer surface of the cooling drum 115 and taken up by a second spool 130. During the rolling of the tape substrate 102 over the outer surface of the cooling drum 115, an electron beam (not illustrated) is directed at a sample of cobalt supported in a crucible 110. The electron beam causes cobalt to be evaporated from the cobalt sample. For illustration, the evaporated cobalt is represented by 111a-f; in practice, there would be many individual molecules of cobalt that would be evaporated.

The cobalt molecules are largely shielded from being deposited directly one tape substrate 102 after evaporation by shields 105, 150, and 155; rather the cobalt condenses out onto substrate 102 as the cobalt cools. Further, oxygen is introduced to react with a portion of the cobalt to form cobalt oxide. The cobalt oxide forms a seed layer on tape substrate 102, passivates the elemental cobalt, as well as separate individual domain sites or columns of cobalt in the recording layer, resulting in data storage tape 120.

In this example, the cobalt is deposited on the substrate 102 as the substrate curves around the roller 115, which results in the cobalt being deposited on a moving surface. This results in the cobalt deposits depending on the incident direction of the deposition vapor. For example, because the roller is moving substrate 102 along a curve, the cobalt columns generally are not deposited in a straight vertical arrangement; rather, they deposit in a curved shape, which has traditionally been referred to in the art as a “banana” shape.

FIG. 2 illustrates a cross-sectional schematic view of an exemplary data storage tape having an AME coating or layer 230 disposed (as described with respect to FIG. 1, for example) on a major side or surface of a flexible substrate 220. As shown, the AME coating 230 includes a plurality of individual columns 232 of cobalt, which have a curved “banana” shape. Each column 232 may include multiple cobalt particles, each of which may serve as an individual domain.

Recording to AME layer 230 is performed generally in a vertical fashion (e.g., along the direction of the thickness of the substrate 220 and tape 200), rather than longitudinally or parallel to the surface of the substrate 220, as is typical with MP media. Additionally, AME layer 230 is generally “keepered,” wherein the flux from adjacent bit cells tends to reinforce, rather than induce stress demagnetization as common with longitudinal recording. Both of these features will mitigate the issues of print-through and contact recording as discussed with MP media.

FIG. 2 further illustrates a pair of write pole tips 240, 241 positioned adjacent AME layer 230. Further, a write flux path 242 is illustrated schematically by arrows from leading pole tip 240 to trailing pole tip 241 during a typical write operation. It is noted that write flux path 242 is illustrative only, and the primary flux path jumps the gap between pole tips 240, 241, where flux path 242 is a portion of the leakage flux from the saturation of this gap that is primarily used to write. Additionally, flux path 242 is drawn to illustrate generally that as flux leaves the leading pole tip 240, it will tend to follow along a column 232 of cobalt in close proximity thereto until the flux can return though a path of least reluctance through adjacent columns 232 and to trailing pole tip 241.

During the writing process, the orientation of the final flux through each domain or column 232 as it passes through flux path 242 determines the recorded magnetization. Accordingly, if the media moves from right to left as shown in FIG. 2, column 232 passes leading pole tip 240 first such that the magnetization of column 232 will be substantially uniform through its entire depth. In contrast, if the media moves from left to right, each column would pass pole tip 241 last such that the final magnetization will be a short, vertical portion of column 232 near pole tip 241. The remainder of column 232 may vary and depend on the history from the leading pole tip 240, which depending on the run length, may be randomized.

Accordingly, if the media is moving from left to right, the leading domains (columns 232) form an extension of the leading pole tip 241 below the written domains, and vertical recording is achieved (with all of the advantages of vertical recording such as potentially higher density recording). Additionally, depending on the maximum run length written and the geometry of column 232, the depth of magnetic recording may be limited to the upper portion of column 232, which may reduce saturation in an MR read element and reduce or eliminate the need to write equalize.

Accordingly, in one example, the AME layer 230 is preferably recorded in a direction taking advantage of the curved shape of columns 232, and is thus generally considered a uni-directional media (e.g., where the media is more effectively and/or efficiently written from right to left than left to right in this instance).

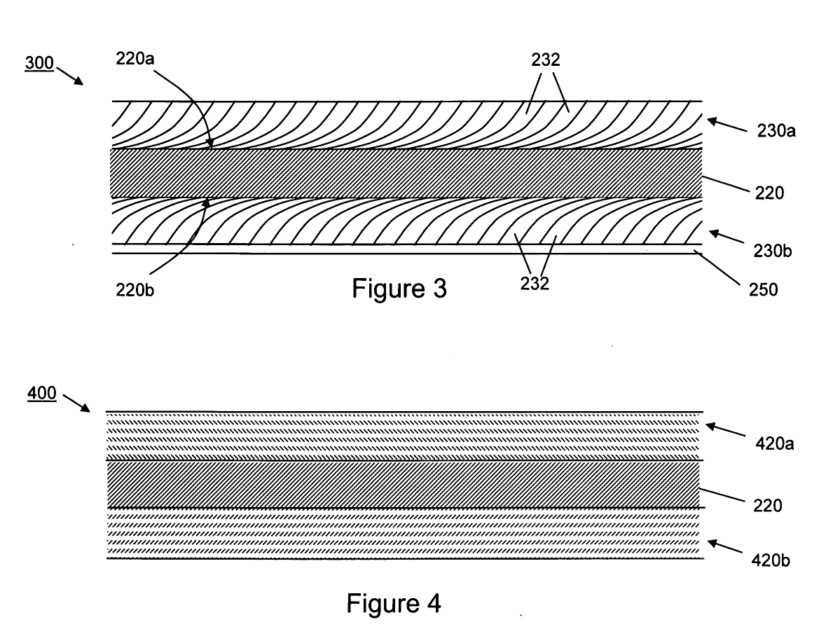

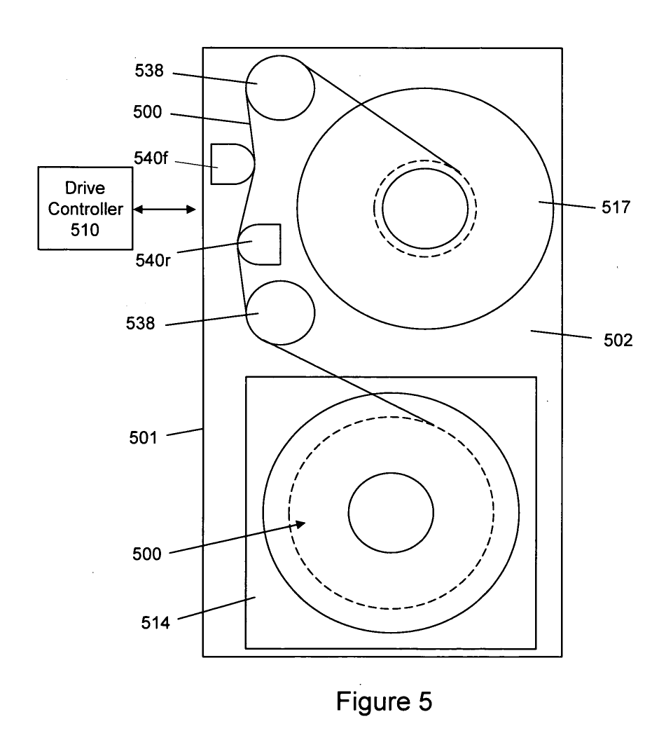

FIG. 3 illustrates an exemplary storage tape 300 having first and second AME layers 230a and 230b disposed on (i.e., on or adjacent) both major surfaces 220a, 220b of substrate 220, the AME layers 230a and 230b oriented in opposite directions. AME layers 230a and 230b, disposed on opposing sides of substrate 220, each comprise columns 232 as described generally with respect to FIG. 2. Further, as shown, columns 232 are oriented in opposite (or at least, different) orientations. As described in greater detail below with respect to FIG. 5, a drive may include heads positioned on either side of a tape path and operable to perform data transfer functions (e.g., read, write, or both) to AME layers 230a and 230b. The heads on each side may be configured for the uni-directional nature of the AME layers 230a and 230b, e.g., where one of the heads operates in a first direction and the other of the heads operating in the reverse direction.

Additionally, in one example, at least one of the AME layers 230a and 230b may include material or a manufacturing process designed to allow for separation from the opposing AME layers when in contact (e.g., when wound on a reel). In other examples, a coating or layer shown as separation layer 250 may be disposed over one or both of AME layers 230a and 230b. Separation layer 250 may include various materials such as Diamond Like Coatings (DLC), or the like, which may reduce adhesion and allow separation from the opposing surface when wound on a reel. Separation layer 250 or similar coating(s) may also generally provide protection and or lubrication to the surface thereof.

AME layers 230a and 230b may be disposed sequentially onto substrate 220 in any suitable fashion, including two sequential passes through a system similar to that shown in FIG. 1. Additionally, the two coatings may be applied in a single pass system; for example, where major surfaces 220a and 220b of substrate 220 are coated with AME layers 230a and 230b simultaneously or at least in a single pass operation.

Substrate 220 may include various flexible materials including a plastic substrate such as PolyEthylene Terephthalate (PET), PolyEthylene Naphthalene (PEN), PolyAramid (PA), or the like. Further, although shown and described as a single layer, it should be understood that substrate 220 may include any number of layers or different materials depending on the particular application.

It will be recognized that the thickness of AME layers 230a, 230b, separation layer 250, and substrate 220 are not drawn to scale. For example, the thickness of substrate 220 may be on the order of microns, and in one example between 3 and 5 microns; the thickness of AME layers 230a and 230b may be less than 1 micron, and in one example between 30 nm and 200 nm; and the thickness of separation layer 250 may be on the order of nano-meters or less, and in one example between 5-15 nm. Of course, these thickness values and ranges are for illustrative purposes and thickness values greater or less than stated here are contemplated.

It is noted that AME layers 230a and 230b record information in a vertical fashion (e.g., along the vertical depth of columns 232). This provides the potential advantage of increasing the volume of the recorded bit cell over a longitudinal orientation, thereby increasing the potential storage density for a give surface area of tape 300. For example, a recorded bit cell extends deeper into the recording layer than in the case of MP media, providing a portion of the bit-cell that is under less stress.

AME layers 230a and 230b are also “keepered,” wherein the flux from a given bit-cell tends to return to itself though adjacent bits and thus the flux from adjacent bit cells tends to reinforce, rather than induce stress-demagnetization (as typically with longitudinal recording such as with MP media). Both characteristics would tend to mitigate the issue of print-though and contact recording when tape 300 is wound on a reel and AME layers 230a and 230b are in contact (or at least disposed in closed proximity).

FIG. 4 illustrates an exemplary storage tape 400 having uni-directional recording layers 430a and 430b disposed on or adjacent major surfaces 420a and 420b of substrate 420. Similar to FIG. 3, uni-directional recording layers 430a and 420b are oriented in opposite (or at least non-identical) directions. Recording layers 430a and 430b may include a material suitable for magnetic recording and which may store magnetization in a more efficient or dense manner along a first direction than along a second direction (e.g., where the first and second directions are opposite or at least non-identical).

FIG. 5 illustrates an exemplary tape drive 501 for use with an exemplary storage tape cartridge 514 housing a dual sided, uni-directional media 500. Tape drive 501 includes a base 502 for supporting, amongst other features, a take-up reel 517 and guide rollers 528, which define a tape path adjacent data transducer heads 540f and 540r from the cartridge to take-up reel 517. Additionally, tape drive 501 may include a receiver (not shown) for receiving tape cartridge 514 therein, as well as various buckle mechanism or the like to engage and pull media 500 from cartridge 514 to take-up reel 517.

In one example, as media 500 is pulled from cartridge 514 and wound on take-up reel 517, a forward data transducer head 540f is active and performs data transfer operations on media 500, while a reverse data transducer head 540r is inactive (e.g., does not perform data transfer operations). As the direction of transport of media 500 is reversed and spooled back to the reel of cartridge 514, forward data transducer head 540f is inactive and reverse data transducer head 540r is active for performing data transfer operations. In this manner, tape drive 501 may operate in a bi-directional manner within a linear tape drive using uni-directional media.

The control and operation of media 500 and data transducer heads 540f and 540r may be controlled by a drive controller 510 included with tape drive 501 and base 502, or alternatively, by a host system. For example, drive controller 510 includes or accesses logic for carrying out various aspects described herein. Such logic may be included in hardware, software, firmware, or combinations thereof as will be recognized by one of ordinary skill in the art.

In other examples, data transducer heads 540r and 540f may be active during both forward and reverse directions of tape transport for data transfer functions. Further, in some examples, one of the first transducer head 540r and 540f may be active for data transfer functions and the other active to perform servo functions. Further, it will be recognized that various other features and configurations of tape drive 501 are possible and contemplated. For example, the number and position of guide rollers 528, transducer heads, guide surfaces, and the like included with drive 501 may be altered for various different application and design considerations.

It is noted that the use of the term “tape” herein is used for illustrative purposes, and refers generally to any flexible magnetic storage media, and does not require the use of a media having a substantially longer longitudinal dimension than width as with conventional tape media.

The above detailed description is provided to illustrate various examples and is not intended to be limiting. It will be apparent to one of ordinary skill in the art that numerous modifications and variations within the scope of the present invention are possible. Further, throughout this description, particular examples have been discussed and how these examples are thought to address certain disadvantages in related art. This discussion is not meant, however, to restrict the various examples to methods and/or systems that actually address or solve the disadvantages. Accordingly, the present invention is defined by the appended claims and should not be limited by the description herein.

We claim:

1. A data storage tape, comprising:
a flexible substrate;
a first recording layer and a second recording layer disposed on opposite sides of the substrate, wherein each of the first and second recording layers are uni-directional, and the first and second recording layers are oriented in different directions.

2. The data storage tape of claim 1, wherein the first recording layer comprises an advanced metal evaporated coating.

3. The data storage tape of claim 1, wherein the first recording layer and the second recording layer comprise advanced metal evaporated coatings.

4. The data storage tape of claim 1, wherein the first recording layer is configured for vertical recording.

5. The data storage tape of claim 1, wherein the first and second recording layers are oriented in opposite directions.

6. The data storage tape of claim 1, wherein the first recording layer is entirely uni-directional in a first direction, and the second recording layer is entirely uni-directional in a second direction.

7. The data storage tape of claim 1, further comprising an exposed separation layer disposed on a first side of the tape, the separation layer for reducing adhesion to an opposite second side of the tape.

8. A dual-sided data storage tape, comprising:
a flexible substrate having first and second major surfaces;
a first advanced metal evaporated coating disposed on the first major surface, the first metal evaporated coating oriented in a first direction; and
a second advanced metal evaporated coating disposed on the second major surface, the second metal evaporated coating oriented in a second direction, the second direction different that the first direction.

9. The data storage tape of claim 8, wherein the first and second advanced metal evaporated coatings are disposed in opposite directions.

10. The data storage tape of claim 8, wherein the first advanced metal evaporated coating is substantially unidirectional in a first direction, and the second advanced metal evaporated coating is substantially uni-directional in a second direction.

11. The data storage tape of claim 8, further comprising an exposed separation layer disposed on a first side of the tape, the separation layer for reducing adhesion to an opposite second side of the tape.

12. A magnetic storage tape drive, the tape drive comprising:
a first head disposed on a first side of a tape path, the first head for data transfer operations associated with a first uni-directional recording layer oriented in a first direction; and
a second head disposed on a second side of the tape path, the second head for data transfer operations associated with a second uni-directional recording layer oriented in a second direction, wherein the first direction and second direction are oriented in non-identical directions.

13. The tape drive of claim 12, wherein the first head is operable for data transfer operations in a first direction of tape transport, and the second head is operable for data transfer operations in a second direction of tape transport.

14. The tape drive of claim 12, wherein the first recording layer comprises an advanced evaporated metal evaporated coating.

15. The tape drive of claim 12, wherein the first recording layer and the second recording layer comprise advanced metal evaporated coatings.

16. The tape drive of claim 12, wherein the first and second directions are oriented in opposite directions.

17. A method for forming a magnetic storage tape, comprising:
disposing a first recording layer on a first side of a substrate, the first recording layer comprising a uni-directional recording layer; and
disposing a second recording layer on a second side of a substrate, the second recording layer comprising a uni-direction recording layer, the orientation of the second recording layer different than the first recording layer.

18. The method of claim 17, wherein the first recording layer comprises an advanced metal evaporation coating.

19. The method of claim 17, wherein the first recording layer and the second recording layer comprise advanced metal evaporation coatings.

20. The method of claim 17, wherein disposing the first and second recording layers is done at least partially simultaneously.

21. The method of claim 17, wherein disposing the first and second recording layers is done in series.
